(19) United States
(12) Patent Application Publication
(10) Pub. No.: US 2003/0163556 A1
(43) Pub. Date: Aug. 28, 2003

(54) Management apparatus, interconnecting device, communication system, program and management method

(75) Inventor: Jun Haneda, Tokyo (JP)

Correspondence Address: RYUKA, 1-24-12 SHINJUKU, SIXTH FLOOR, TOSHIN BUILDING, SHINJUKU-KU, TOKYO, 160-0022, JP

(73) Assignee: ALLIED TELESIS K.K., Tokyo (JP)

(21) Appl. No.: 10/064,315

(22) Filed: Jul. 2, 2002

(30) Foreign Application Priority Data
Feb. 26, 2002 (JP) 2002-050353

(51) Int. Cl. G06F 15/173

(52) U.S. Cl. 709/223

(57) ABSTRACT

A management apparatus for managing a plurality of interconnecting devices which interconnects communication, comprising: a command storage unit for storing one or more execution procedures, which correspond to a common command for managing the interconnecting devices and process the command for the respective interconnecting devices; and an execution unit for executing the command for one of the interconnecting devices, by fetching the execution procedure corresponding to the command for the one of the interconnecting devices from the command storage unit, and for communicating with the one of the interconnecting devices in accordance with the execution procedure.

### CROSS REFERENCE TO RELATED APPLICATIONS

This patent application claims priority from a Japanese patent application, No. 2002-050353 filed on Feb. 26, 2002, the contents of which are incorporated herein by reference.

### BACKGROUND OF INVENTION

1. Field of the Invention

The present invention relates to a management apparatus, an interconnecting device, a communication system, a program, and a management method. More particularly, the present invention relates to a management apparatus, an interconnecting device, a communication system a program and a management method in order to manage a plurality of interconnecting devices to interconnect communication.

2. Description of the Related Art

A technique to manage a plurality of interconnecting devices to interconnect a communication apparatus is disclosed in, e.g., Japanese Patent Application Laid-Open No. 11-340980. In the Japanese Patent Application Laid-Open No. 11-340980, a manager program provides with a procedure setting module for developing a procedure which changes a setting for an interconnecting device, in a manner of a sequence for setting a device, using a device setting information DB which stores device set data required for management. The procedure setting module has a SNMP command sequential module for creating a device control sequence as a command column of SNMP (simple network management protocol). As to protocols except for SNMP, preparing a similar module for creating command sequence may achieve a function to collect information of or set a device without having an interface of SNMP.

In the Japanese Patent Application Laid-Open No. 11-340980, when different types of interconnecting devices are connected to a network system, it is necessary to prepare the module for creating command sequence corresponding to this interconnecting device and incorporate the module for creating command sequence into the management manager program. To further easily manage the network system, it is preferable to provide a function to easily corporate a processing procedure corresponding to the interconnecting device.

### SUMMARY OF INVENTION

Therefore, it is object to provide a management apparatus, an interconnecting device, a communication system, a program and a management method, which are capable of overcoming the above drawbacks accompanying the conventional art. The above and other objects can be achieved by combinations described in the independent claims. The dependent claims define further advantageous and exemplary combinations of the present invention.

According to the first aspect of the invention, there is provided a management apparatus for managing a plurality of interconnecting devices which interconnects communication, comprising: a command storage unit for storing one or more execution procedures, which correspond to a common command for managing the interconnecting devices and process the command for the respective interconnecting devices; and an execution unit for executing the command for one of the interconnecting devices, by fetching the execution procedure corresponding to the command for the one of the interconnecting devices from the command storage unit, and for communicating with the one of the interconnecting devices in accordance with the execution procedure.

In the management apparatus, the execution unit may establish VLAN to the one of the interconnecting devices, by executing the command for the one of the interconnecting devices.

In the management apparatus, the execution unit either may create the VLAN to the one of the interconnecting devices or may delete the VLAN from the one of the interconnecting devices, by executing the command for the one of the interconnecting devices.

In the management apparatus the execution unit either may add a communication apparatus to the VLAN set to the one of the interconnecting devices or delete a communication apparatus from the VLAN set to the one of the interconnecting devices, by executing the command for the one of the interconnecting devices.

The management apparatus may further comprises a fetch unit for fetching the execution procedure of the one of the interconnecting devices from the one of the interconnecting devices, and for storing the fetched execution procedure into the command storage unit.

In the management apparatus, the one of the interconnecting devices may store the execution procedure in MIB (Management Information Base) of SNMP(Simple Network Management Protocol), and the fetch unit may fetch the execution procedure from MIB of the one of the interconnecting devices using SNMP.

In the management apparatus, in case where the execution procedure includes a procedure of fetching an address of an interconnecting management apparatus for managing the one of the interconnecting devices, the execution unit may fetch the address of the interconnecting management apparatus from the one of the interconnecting devices, and the execution unit may manage the one of the interconnecting devices through the interconnecting management apparatus, according to the execution procedure of the command, by communicating with the interconnecting management apparatus using the address.

According to the second aspect of the invention, there is provided an interconnecting device for interconnecting communication in a network, comprising: a storage unit for storing an execution procedure which corresponds to a command executed by a management apparatus of the interconnecting device to manage the interconnecting device, and processes the command; a receiver for receiving a fetch request for fetching the execution procedure from the management apparatus; a transmitter for fetching the execution procedure specified by the fetch request from the storage unit, and for transmitting the fetched execution procedure to the management apparatus; and a setting unit for setting the interconnecting device according to a process request sent to the interconnecting device by the management apparatus, based on the execution procedure, when the management apparatus executes the command based on the execution procedure.

In the interconnecting device, the storage unit may store the execution procedure in MIB of SNMP, the receiver may receive the fetch request as a message format based on SNMP, and the transmitter transmits the execution procedure in the message format based on SNMP.

In the interconnecting device, the execution procedure may include steps of: making the management apparatus fetch an address of an interconnecting management apparatus which manages the interconnecting device; and making the management apparatus manage the interconnecting device via the interconnecting management apparatus of the interconnecting device, by communicating with the interconnecting management apparatus.

According to the third aspect of the invention, there is provided a communication system comprising: a plurality of interconnecting devices for interconnecting communication; and a management apparatus for managing the plurality of interconnecting devices, wherein the management apparatus includes a command storage unit for storing one or more execution procedures, which corresponds to a common command for managing the interconnecting devices and process the command for the respective interconnecting devices, a fetch unit for fetching the execution procedure of one of the interconnecting devices from the one of the interconnecting devices, and for storing the fetched execution procedure into the command storage unit, and an execution unit for executing the command for the one of the interconnecting devices, by fetching the execution procedure corresponding to the command for the one of the interconnecting devices from the command storage unit, and by communicating with the one of the interconnecting devices in accordance with the execution procedure; and the one of the interconnecting devices includes a storage unit for storing the execution procedure, which corresponds to the command executed by the management apparatus managing the one of the interconnecting devices, and processes the command, a receiver for receiving a fetch request to fetch the execution procedure from the management apparatus, a transmitter for fetching the execution procedure specified by the fetch request from the storage unit, and for transmitting the fetched execution procedure to the management apparatus; and a setting unit for setting the one of the interconnecting devices according to a process request sent to the one of the interconnecting devices by the management apparatus based on the execution procedure when the execution unit of the management apparatus executes the command based on the execution procedure.

According to the fourth aspect of the invention, there is provided a computer readable medium recording a program for a management apparatus to manage a plurality of interconnecting devices, which interconnect communication, wherein the program makes the management apparatus be operated as: a command storage unit for storing one or more execution procedures, which correspond to a common command for managing the interconnecting devices and process the command for the respective interconnecting devices; and an execution unit for executing the command for one of the interconnecting devices, by fetching the execution procedure corresponding to the command for the one of the interconnecting devices from the command storage unit, and by communicating with the one of the interconnecting devices in accordance with the execution procedure.

According to the fifth aspect of the invention, there is provided a management method of managing a plurality of interconnecting devices for interconnecting communication, comprising steps of: storing one or more execution procedures, which corresponds to a common command for managing the interconnecting devices and process the command for the respective interconnecting devices; and executing the command to one of the interconnecting devices, by fetching the execution procedure corresponding to the command for the one of the interconnecting devices from the command storage unit, and by communicating with the one of the interconnecting devices in accordance with the execution procedure.

This summary of the present invention does not necessarily describe all necessary features so that the invention may also be a sub-combination of these described features.

### BRIEF DESCRIPTION OF DRAWINGS

FIG. 1 shows one example of network system 100 according to the present embodiment.

FIG. 2 shows management apparatus 130 according to the present embodiment.

FIG. 3 shows interconnecting device 120a according to the present embodiment.

FIG. 4 shows interconnecting device 120c according to the present embodiment.

FIG. 5 shows one example of a command storage table stored in command storage unit 230 in the present embodiment.

FIG. 6 shows a flow of a VLAN setting process of interconnecting device 120a by management apparatus 130 in the present embodiment.

FIG. 7 shows a flow of the VLAN setting process of interconnecting device 120c by management apparatus 130 in the present embodiment.

FIG. 8 shows one example of components in a hardware in management apparatus 130 according to the present embodiment.

### DETAILED DESCRIPTION

The invention will now be described based on preferred embodiments, which do not intend to limit the scope of the present invention, but rather to exemplify the invention. All of the features and the combinations thereof described in the embodiments are not necessarily essential to the invention.

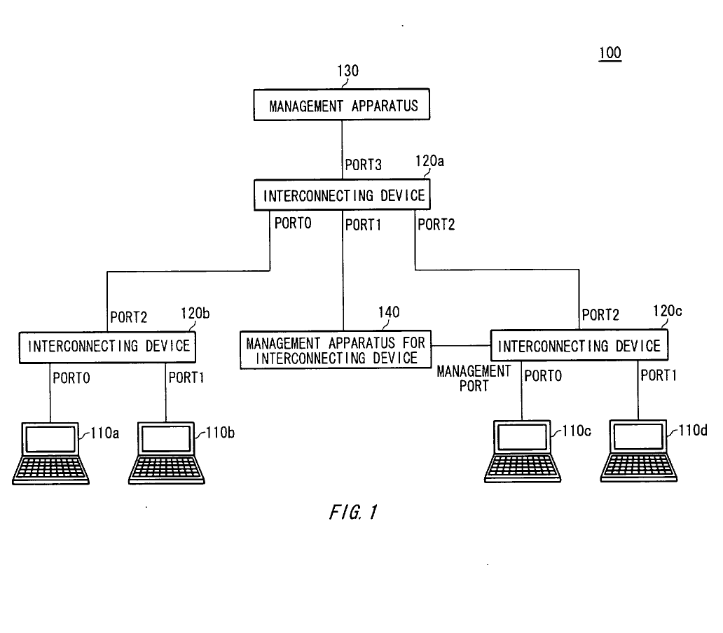

FIG. 1 shows one example of network system 100 according to the present embodiment. Network system 100 has terminals 110a, 110b, 110c and 110d; interconnecting devices 120a, 120b and 120c; management apparatus 130; and management apparatus for interconnecting device 140. Terminals 110a to 110d, interconnecting devices 120a to 120c, management apparatus 130 and management apparatus for interconnecting device 140 are one example of communication apparatuses in the present invention.

Terminals 110a to 110d are used to access share data stored the other terminals through a network by a user. Interconnecting devices 120a to 120c connects terminals 110a to 110d, management apparatus 130 and management apparatus for interconnecting device 140. Interconnecting devices 120a to 120c relay communication among these communication apparatuses. Interconnecting devices 120a to 120c in the present embodiment are switches having a VLAN (virtual LAN) function. Instead, interconnecting devices 120a to 120c may be various interconnecting devices such as hub, router, layer 3 switch, bridge and/or gateway.

Management apparatus 130 manages interconnecting devices 120a to 120c in network system 100. Management apparatus 130 manages interconnecting device 120b via interconnecting device 120a. Management apparatus 130 manages interconnecting device 120c via interconnecting device 120a and an interconnecting management apparatus 140. Management apparatus 130 converts a management operation by an administrator of network system 100 input from management apparatus 130 or terminals 110a to 110d into a sequence of common commands to interconnecting devices 120a to 120c. By executing these commands, management apparatus 130 manages interconnecting devices 120a to 120c. The interconnecting management apparatus 140 connects with a management port of interconnecting device 120c and manages interconnecting device 120c. Management apparatus 130 manages interconnecting device 120c via the interconnecting management apparatus 140.

The network system 100 in the present embodiment will be described as a local area network. Network system 100, however, may be a public communication network such as the Internet or a public telephone; various networks such as a local area network; or combination thereof.

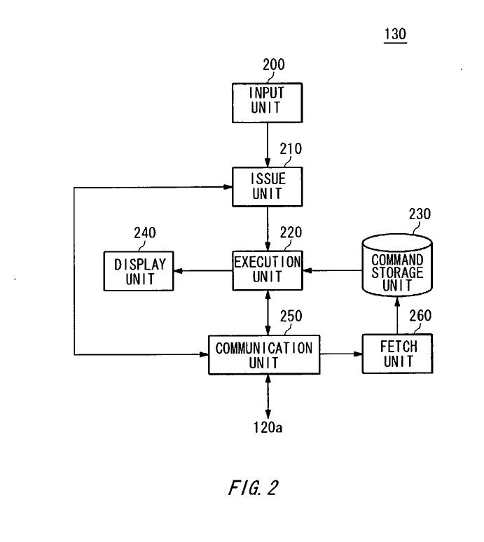

FIG. 2 shows management apparatus 130 according to the present embodiment. Management apparatus 130 has an input unit 200, an issue unit 210, an execution unit 220, a command storage unit 230, a display unit 240, a communication unit 250 and a fetch unit 260.

The input unit 200 inputs the management operation by the administrator in network system 100 directly, or either from the other communication apparatuses such as terminals 110a to 110d, or the interconnecting devices and the communication unit 250. According to the management operation received from input unit 200, the issue unit 210 issues the common command to interconnecting devices 120a to 210c for execution unit 220 in order to manage interconnecting devices 120a to 120c.

The execution unit 220 fetches an execution procedure to process the command from the command storage unit 230. The execution unit 220 communicates among the interconnecting devices in accordance with the execution procedure fetched from the command storage unit 230, and process the setting corresponding to the command for the interconnecting device.

The display unit 240 displays an execution result of various command with the management operation for the administrator in the network system 100. The communication unit 250 communicates with management among the management apparatus 130, the interconnecting management apparatus 140, the interconnecting devices 120a to 120c, and performs a communication process to receive the management operation for the management apparatus 130 from the terminals 110a to 110d.

The fetch unit 260 fetches execution procedures of respective interconnecting devices 120a to 120c from respective interconnecting devices 120a to 120c, and stores the fetched procedures into command storage unit 230. In a case where the execution procedure of the interconnecting device is not stored into command storage unit 230 in executing an special command, fetch unit 260 fetches the execution procedure from the interconnecting device. In these processes, fetch unit 260 requests to fetch the execution procedure held in the interconnecting device of interest. Fetch unit 260 receives the execution procedure sent back by the interconnecting device via communication unit 250, and stores the execution procedure into command storage unit 230. In the present embodiment, the fetch unit 260 transmits a GET REQUEST message of SNM to get the execution procedure stored into the interconnecting device as MIB (management information base). Instead of this, the fetch unit 260 may transmit a message style based on the other protocols such as a protocol defined individually by manufacturer of management apparatus 130 and/or interconnecting devices 120a to 120c or a protocol to use a general IP protocol.

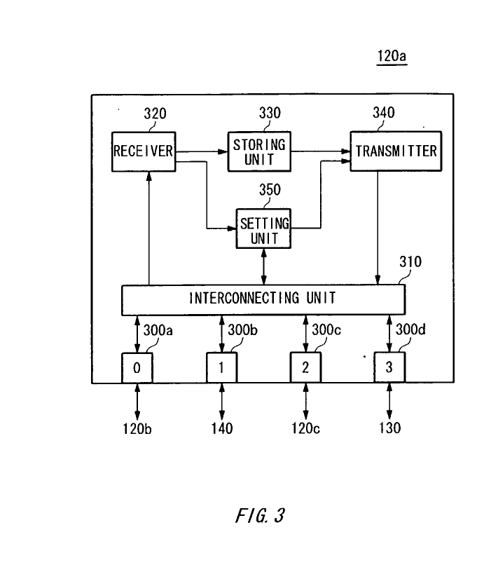

FIG. 3 shows the interconnecting device 120a according to the present embodiment. The interconnecting device 120a includes communication ports 300a, 300b, 300c and 300d; an interconnecting unit 310; a receiver 320; a storing unit 330; a transmitter 340; and a setting unit 350. Since an interconnecting device 120b has a configuration similar to one of interconnecting device 120a, a description is omitted.

Communication ports 300a to 300d connect to the other communication apparatuses, and communicate among the connected communication apparatuses. The interconnecting unit 310 relays communication among the communication ports 300a to 300d. The receiver 320 transmits get request to fetch the execution procedure of the interconnecting device and access request for various types of setting information from the management apparatus 130 via the interconnecting unit 310. Access request is transmitted to the interconnecting device 120a at a time where the management apparatus 130 executes the execution procedure. The receiver 320 in the present embodiment corresponds to get request (GET REQUEST message) of the message style based on SNMP and access request (GET REQUEST and SET REQUEST message). Get request and/or access request received by receiver 320 may be the message style based on the other protocols such as the protocol defined individually by manufacturer of management apparatus 130 and/or interconnecting device 120a or the protocol to use the general IP protocol.

The storing unit 330 stores the execution procedure corresponding to a command executed by the management apparatus 130 to manage the interconnecting device 120a. The execution procedure held by the storing unit 330 is previously written by the manufacturer of the interconnecting device 120a. The storing unit 330 in the present embodiment stores the execution procedure in MIB of SNMP. Thereby, the management apparatus 130 can get the execution procedure on MIB by issuing get request, which is the GET REQUEST message of SNMP.

The transmitter 340 gets the execution procedure specified by get request received from the storing unit 330 by the receiver 320, and transmits the execution procedure back to the management apparatus 130 via the interconnecting unit 310. The transmitter 340 transmits the execution procedure back using a GET RESPONSE message based on SNMP corresponding to get request, which is the GET REQUEST message of SNMP. When the management apparatus 130 executes the command based on the execution procedure sent back by the transmitter 340, the setting unit 350 sets the interconnecting device 120a to correspond to process request such as the access request transmitted to the interconnecting device 120a by the management apparatus 130 based on the execution procedure. When the setting unit 350 receives access request to set VLAN from the management apparatus 130, the setting unit 350 sets VLAN of the interconnecting device 120a by changing, e.g., filtering database of IEEE802.1Q held within the interconnecting unit 310.

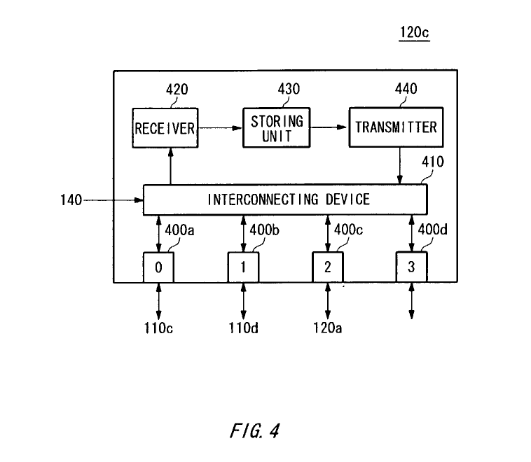

FIG. 4 shows interconnecting device 120c according to the present embodiment. The interconnecting device 120c includes communication ports 400a, 400b, 400c and 400d; an interconnecting unit 410; a receiver 420; a storing unit 430; and a transmitter 440. Since communication ports 400a to 400d, a receiver 420, a storing unit 430 and a transmitter 440 in the interconnecting device 120c of the present embodiment are the almost same as the communication ports 300a to 300d, the receiver 320, the storing unit 330 and the transmitter 340 in the interconnecting device 120a as shown in FIG. 3, descriptions are omitted.

The interconnecting unit 410 relays communication among the communication ports 400a to 300d. The interconnecting unit 410 connects with the interconnecting management apparatus 140 via, e.g., a cable for management such as RS-232C cable. A method of relaying communication etc. is set by the interconnecting management apparatus 140. When the management apparatus 130 executes the command based on the execution procedure sent back by the transmitter 440, the interconnecting management apparatus 140 sets the interconnecting device 120c to correspond to process request such as access request transmitted to the interconnecting management apparatus 140 by the management apparatus 130 based on the execution procedure.

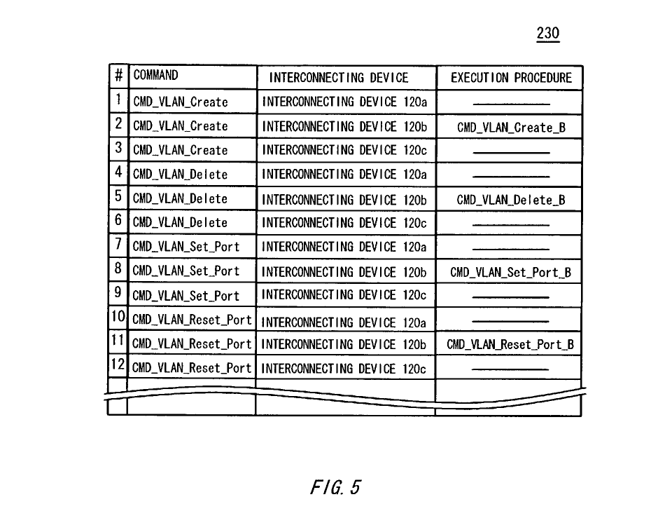

FIG. 5 shows one example of a command storage table stored in the command storage unit 230 in the present embodiment. The command storage table stored in the command storage unit 230 has a field of command, a field of interconnecting device, and a field of execution procedure.

The field of command stores identifying names of the common commands to the interconnecting devices 120a to 120c issued by the issue unit 210 to manage the interconnecting devices 120a to 120c. The field of interconnecting device stores information that identifies interconnecting devices. The field of execution procedure stores the execution procedure corresponds to the command specified in the field of command and the interconnecting device specified in the field of interconnecting device.

Command storage unit 230 has various commands to set VLAN of the interconnecting device as the common command to interconnecting devices 120a to 120c. Concretely, command storage unit 230 has a “CMD_VLAN_Create” command to create VLAN in the interconnecting device, a “CMD_VLAN_Delete” command to delete VLAN of the interconnecting device, a “CMD_VLAN_Set_Port” command to add the communication apparatus to VLAN set in the interconnecting device, and a “CMD_VLAN_Reset_Port” command to delete the communication apparatus from VLAN set in the interconnecting device.

For example, in a first line of FIG. 5, it is shown that management apparatus 130 does not get the execution procedure, to execute “CMD_VLAN_Create” command for interconnecting device 120a, from interconnecting device 120a. In a second line of FIG. 5, it is shown that management apparatus 130 gets “CMD_VLAN_Create_B” of the command processing procedure to execute “CMD_VLAN_Create” command for interconnecting device 120bfrom interconnecting device 120b. When execution unit 220 in management apparatus 130 executes the command for the interconnecting device, execution unit 220 gets the execution procedure of the interconnecting device corresponding to the command from command storage unit 230. In a case where execution unit 220 does not get the corresponding execution procedure, after fetch unit 260 fetches the corresponding execution procedure and the fetched execution procedure is stored in command storage unit 230, execution unit 220 fetches the corresponding execution procedure from command storage unit 230.

The execution procedure stored in the command storage unit 230 may be various types such as a code whose compilation is performed directly executed by the execution unit 220 in management apparatus 130 and a code whose compilation is not performed executed by the execution unit 220 in the management apparatus 130 while interpretation is made by the execution unit 220. Execution procedure stored in the command storage unit 230 may be large in comparison with a size to get by one SNMP message. In this case, the fetch unit 260 may issue a plurality of GET REQUEST messages for the interconnecting device and get execution procedure. In addition, the fetch unit 260 may fetch a portion executed by the execution unit 220 in command processing procedure from the interconnecting device if required, and stored the fetch portion in the command storage unit 230.

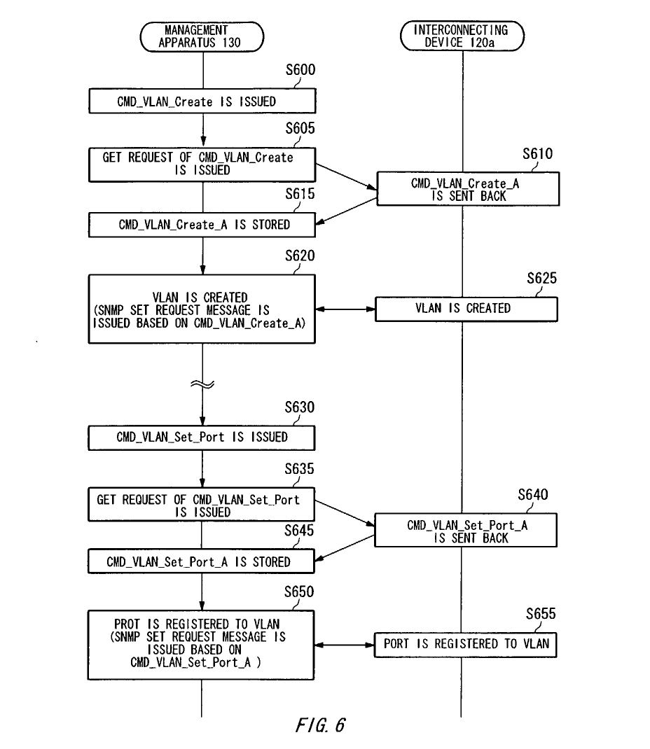

FIG. 6 shows a flow of a VLAN setting process of the interconnecting device 120a by the management apparatus 130 in the present embodiment.

At first, the input unit 200 inputs the management operation to set VLAN by the administrator in the network system 100. The issue unit 210 issues “CMD_VLAN_Create” command corresponding to the management operation to execution unit 220 (S600). Next, the execution unit 220 tries to get, the execution procedure to process “CMD_VLAN_Create” command for the interconnecting device 120a, from the command storage unit 230. If the corresponding execution procedure is not stored in the command storage unit 230, the execution unit 220 requests the fetch unit 260 to fetch the corresponding execution procedure. By this request, the fetch unit 260 issues GET REQUEST message, which is get request of “CMD_VLAN_Create” command to the interconnecting device 120a (S605). When the interconnecting device 120a receives get request of “CMD_VLAN_Create” command, the interconnecting device 120a gets “CMD_VLAN_Create” command, which is the execution procedure of “CMD_VLAN_Create” command from the storing unit 330 and transmits the got command back to the management apparatus 130 (S610). The fetch unit 260 receives the execution procedure “CMD_VLAN_Create” from the interconnecting device 120a and stores the received command in the portion corresponding to the command storage table in the command storage unit 230 (S615).

When the fetch unit 260 fetches the the execution procedure “CMD_VLAN_Create_A”, the execution unit 220 gets the “CMD_VLAN_Create_A” from the command storage unit 230 to execute that command, and creates VLAN for interconnecting device 120a (S620). In S620, the execution unit 220 issues SET REQUEST message etc. to create VLAN in accordance with the execution procedure “CMD_VLAN_Create_A”. The setting unit 350 in the interconnecting device 120a creates VLAN in the interconnecting device 120a by writing a set value received from the management apparatus 130 into a register for setting VLAN provided on MIB in the interconnecting device 120a to correspond to a SET REQUEST message received from the management apparatus 130 (S625).

After VLAN is created in S600 to S625, the administrator in the network system 100 inputs the management operation to add he communication apparatus to VLAN created in the interconnecting device 120a via input unit 200. The issue unit 210 issues the “CMD_VLAN_Set_Port” command corresponding to the management operation to the execution unit 220 (S630). Execution unit 220 tries to get, the execution procedure to process the “CMD_VLAN_Set_Port” command for interconnecting device 120a, from command storage unit 230. If the corresponding execution procedure is not stored in command storage unit 230, the execution unit 220 requests the fetch unit 260 to fetch the corresponding execution procedure. By this request, the fetch unit 260 issues GET REQUEST message, which is get request of the “CMD_VLAN_Set_Port” command to interconnecting device 120a (S635). When the interconnecting device 120a receives get request of “CMD_VLAN_Set_Port” command, interconnecting device 120a gets the “CMD_VLAN_Set_Port_A”, which is the execution procedure of the “CMD_VLAN_Set_Port” command from storing unit 330 and transmits the got command back to management apparatus 130 (S640). The fetch unit 260 receives the execution procedure “CMD_VLAN_Set_Port_A” from interconnecting device 120a and stores the received procedure in the portion corresponding to the command storage table in command storage unit 230 (S645).

When the fetch unit 260 fetches the execution procedure “CMD_VLAN_Set_Port_A”, the execution unit 220 gets the “CMD_VLAN_Set_Port_A” from command storage unit 230 to execute that command, and adds a special port of interconnecting device 120a to VLAN created in S600 to S625 (S650). In S650, the execution unit 220 issues SET REQUEST message etc. of SNMP to interconnecting device 120a in accordance with a procedure described on the execution procedure “CMD_VLAN_Set_Port_A”. Setting unit 350 in interconnecting device 120a adds the special port in interconnecting device 120a to VLAN created in S600 to S625 by writing the set value received from management apparatus 130 into the register for setting VLAN provided on MIB in interconnecting device 120a to correspond to the SET REQUEST message received from management apparatus 130 (S655). Thereby, setting unit 350 can add the communication apparatus connected to the port to VLAN created in S600 to S625.

Similar to the above process, management apparatus 130 and the interconnecting device 120a execute the “CMD_VLAN_Delete” command to delete VLAN created in the interconnecting device 120a and “CMD_VLAN_Reset_Port” command to delete the communication apparatus by deleting the special port from VLAN created in the interconnecting device 120a.

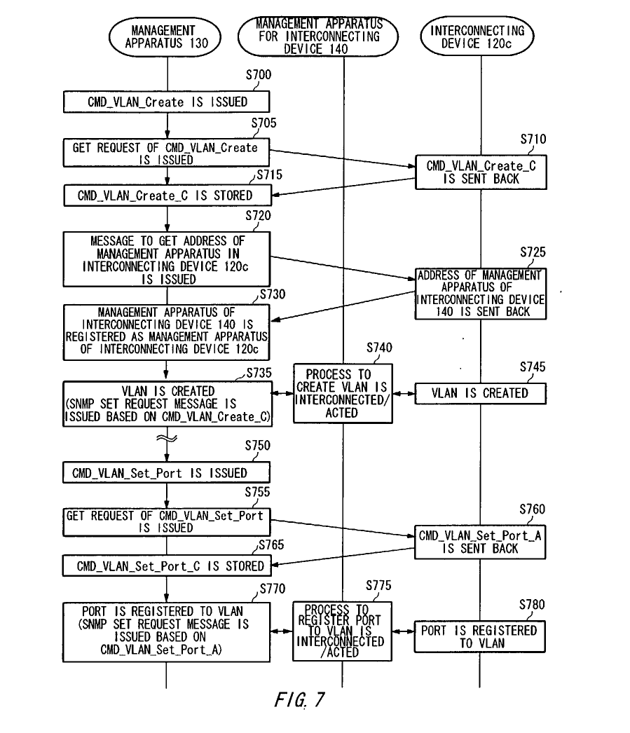

FIG. 7 shows a flow of the VLAN setting process of the interconnecting device 120c by the management apparatus 130 in the present embodiment.

At first, the input unit 200 inputs the management operation to set VLAN by the administrator in the network system 100.

Issue unit 210 issues the “CMD_VLAN_Create” command corresponding to the management operation to the execution unit 220 (S700). Next, the execution unit 220 tries to get, the execution procedure to process the “CMD_VLAN_Create” command for interconnecting device 120c, from command storage unit 230. If the corresponding execution procedure is not stored in command storage unit 230, the execution unit 220 requests the fetch unit 260 to fetch the corresponding execution procedure. By this request, the fetch unit 260 issues GET REQUEST message, which is get request of the “CMD_VLAN_Create” command to interconnecting device 120c (S705). When interconnecting device 120c receives get request of the “CMD_VLAN_Create” command, interconnecting device 120a gets the “CMD_VLAN_Create_C” command, which is the execution procedure of the “CMD_VLAN_Create” command from storing unit 430 and transmits the got command back to management apparatus 130 (S710). Fetch unit 260 receives the execution procedure “CMD_VLAN_Create_C” from interconnecting device 120c and stores the received command in the portion corresponding to the command storage table in command storage unit 230 (S715).

When the fetch unit 260 fetches the execution procedure “CMD_VLAN_Create_C”, the execution unit 220 gets “CMD_VLAN_Create_C” from command storage unit 230 to execute that command, and creates VLAN for interconnecting device 120c (S720). Since interconnecting device 120c is directly managed by management apparatus of the interconnecting device 140 via the management port, the management apparatus 130 manages interconnecting device 120c via the interconnecting management apparatus 140. To realize this, the execution procedure “CMD_VLAN_Create_C” includes to get an address of the management apparatus in the interconnecting device 120c and transmit the access request to the interconnecting device 120c via the management apparatus in the interconnecting device 120c is described. The execution unit 220 issues GET REQUEST message to get the address of the management apparatus in the interconnecting device 120c to the interconnecting device 120c in accordance with the above execution procedure (S720). The interconnecting unit 410 in the interconnecting device 120c transmits the address of management apparatus of the interconnecting device 140, which is the management apparatus set in the interconnecting device 120c back to the management apparatus 130 (S725).

The execution unit 220 in the management apparatus 130 stores the address of management apparatus of the interconnecting device 140 sent back from the interconnecting device 120c as the address of the management apparatus in the interconnecting device 120c (S730). The execution unit 220 issues SET REQUEST message etc. to create VLAN in the interconnecting device 120c to management apparatus of the interconnecting device 140 in accordance with the execution procedure “CMD_VLAN_Create_C” (S735). The interconnecting management apparatus 140 receives SET REQUEST message etc. to create VLAN in the interconnecting device 120c from the management apparatus 130, and sets the interconnecting unit 410 of the interconnecting device 120c via the management port (S740). The interconnecting management apparatus 140 may set interconnecting device 120c by the interconnecting SET REQUEST message etc. attention to the interconnecting device 120c to the interconnecting device 120c. The management apparatus of interconnecting device 140 may receive SET REQUEST message etc. attention to the interconnecting device 120c, convert the received SET REQUEST message into a communication system dedicated in the interconnecting device 120c, and transmit the converted SET REQUEST message to the interconnecting device 120c. The interconnecting unit 410 in the interconnecting device 120c creates VLAN in the interconnecting device 120c by writing the set value received from the management apparatus 130 via the interconnecting management apparatus 140 into the register for setting VLAN provided in interconnecting device 120c (S745).

After VLAN is created in S700 to S745, the administrator in the network system 100 inputs the management operation to add the communication apparatus to VLAN created in the interconnecting device 120c via the input unit 200. The issue unit 210 issues the “CMD_VLAN_Set_Port” command corresponding to the management operation to the execution unit 220 (S750). Next, the execution unit 220 tries to get, the execution procedure to process “CMD_VLAN_Set_Port” command for the interconnecting device 120c, from the command storage unit 230. If the corresponding execution procedure is not stored in the command storage unit 230, the execution unit 220 requests the fetch unit 260 to fetch the corresponding execution procedure. By this request, the fetch unit 260 issues GET REQUEST message, which is get request of “CMD_VLAN_Set_Port” command to the interconnecting device 120c (S755). When the interconnecting device 120c receives get request of the “CMD_VLAN_Set_Port” command, the interconnecting device 120a gets the “CMD_VLAN_Set_Port_C”, which is the execution procedure of “CMD_VLAN_Set_Port” command from storing unit 430 and transmits the got command back to management apparatus 130 (S760). The fetch unit 260 receives the execution procedure “CMD_VLAN_Set_Port_C” from interconnecting device 120c and stores the received command in the portion corresponding to the command storage table in command storage unit 230 (S765).

When the fetch unit 260 fetches the execution procedure “CMD_VLAN_Create_C”, the execution unit 220 gets the “CMD_VLAN_Set_Port_C” from the command storage unit 230 to execute that command, and add the special port in the interconnecting device 120c to VLAN created in S700 to S745 (S770). In S770, the execution unit 220 issues SET REQUEST message etc. of SNMP to management apparatus for interconnecting device 140 in accordance with the execution procedure “CMD_VLAN_Set_Port_Set_Port_C”. Management apparatus of the interconnecting device 140 receives SET REQUEST message etc. to add the special port to VLAN in the interconnecting device 120c from the management apparatus 130, and sets interconnecting unit 410 of interconnecting device 120c via the management port (S775). The interconnecting management apparatus 140 may set interconnecting device 120c by interconnecting SET REQUEST message etc. attention to interconnecting device 120c to interconnecting device 120c similar to S740. The interconnecting management apparatus 140 may receive SET REQUEST message etc. attention to the interconnecting device 120c, convert the received SET REQUEST message into the communication system dedicated in the interconnecting device 120c, and transmit the converted SET REQUEST message to the interconnecting device 120c. The interconnecting unit 410 in the interconnecting device 120c adds the special port to VLAN in the interconnecting device 120c by writing the set value received from the management apparatus 130 via the interconnecting management apparatus 140 into the register for setting VLAN provided in the interconnecting device 120c (S780). Thereby, the setting unit 350 can add the communication apparatus connected to the port to VLAN created in S700 to S745.

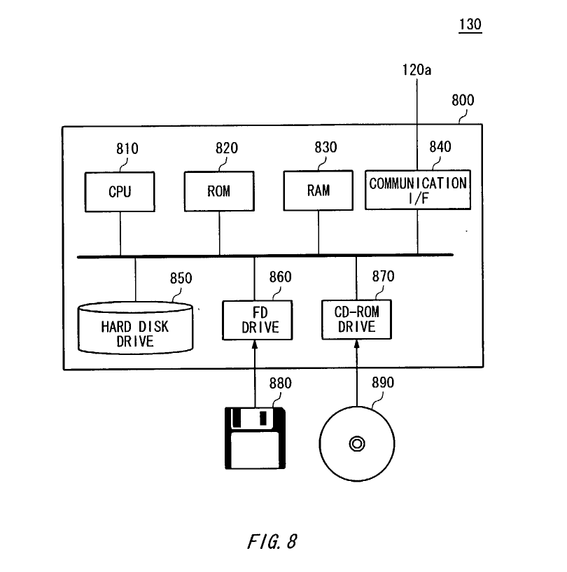

FIG. 8 shows one example of components in a hardware in the management apparatus 130 according to the present embodiment. Functions of the management apparatus 130 in the present embodiment is realized by associating a computer 800 having a CPU 810, an ROM 820, an RAM 830, a communication interface 840 and a hard disk drive 850 with a program executed on a computer 800. A computer 800 may further provide FD drive 860 and/or CD-ROM drive 870.

The program to execute management apparatus 130 has an input module, an issue module, an execution module, a command storage module, a display module, a communication module, a communication module, a fetch module. These modules are programs to make a computer 800 be operated as an input unit 200, an issue unit 210, an execution unit 220, a command storage unit 230, a display unit 240, a communication unit 250 and a fetch unit 260. A hard disk drive 850 may be used to store a command storage table in a command storage unit 230.

The program or modules as described above may be stored in an external recording medium. An optical recording radium such as DVD or PD, an optical magneto recording medium such as MD, a tape medium, a semiconductor memory such as an ID card other than FD 880, or CD-ROM 890 as the recording medium. A storage apparatus such as a hard disk or RAM provided in a server system connected to a dedicated communication network or the Internet is used as the recording medium and the program may be provided a computer 800 via an external network or a network connected to the computer 800.

As described above, the management apparatus 130 in the present embodiment stores execution procedure corresponding to each of a plurality of interconnecting devices 120a to 120c to correspond to the common command to interconnecting devices 120a to 120c. Thereby, management apparatus 130 can manage different types of the interconnecting devices 120a to 120c using the common command. According to the management apparatus 130 and interconnecting devices 120a to 120c of the present embodiment, the manufacturer previously stores the above execution procedure into the interconnecting devices 120a to 120c, and the management apparatus 130 can get the command processing procedure to execute the execution procedure if required. Thereby, the administrator of the network system 100 can further easily manage network system 100 having a plurality of types of interconnecting devices since the administrator does not need to pat attention for getting and building command processing procedure corresponding to the interconnecting devices.

The management apparatus 130 and interconnecting devices 120a to 120c of the present embodiment may communicate using a message etc. based on a protocol defined as base which is SNMP instead of using a message based on SNMP. The management apparatus 130 and the interconnecting devices 120a to 120c of the present embodiment may communicate using a message based on the other protocols such as a dedicated protocol developed by the manufacturer or a protocol using a general IP protocol.

As obvious from the above, according to the present invention it is provided a management apparatus, an interconnecting device, a communication system, a program and a management method having a function to easily incorporate a processing procedure corresponding to the interconnecting device and capable of easily managing the network system.

Although the present invention has been described by way of exemplary embodiments, it should be understood that many changes and substitutions may be made by those skilled in the art without departing from the spirit and the scope of the present invention which is defined only by the appended claims.

1. A management apparatus for managing a plurality of interconnecting devices which interconnects communication, comprising:
a command storage unit for storing one or more execution procedures, which correspond to a common command to the interconnecting devices and process the command for the respective interconnecting devices; and
an execution unit connecting to said command storage unit for executing the command for one of the plurality of interconnecting devices, by fetching the execution procedure corresponding to the command for said one of the interconnecting devices from said command storage unit, and for communicating with said one of the interconnecting devices in accordance with the execution procedure.

2. A management apparatus as claimed in claim 1, wherein said execution unit establishes VLAN to said one of the interconnecting devices, by executing the command for said one of the interconnecting devices.

3. A management apparatus as claimed in claim 2, wherein said execution unit either creates the VLAN to said one of the interconnecting devices or deletes the VLAN from said one of the interconnecting devices, by executing the command for said one of the interconnecting devices.

4. A management apparatus as claimed in claim 2, wherein said execution unit either adds a communication apparatus to the VLAN set to said one of the interconnecting devices or deletes a communication apparatus from the VLAN set to said one of the interconnecting devices, by executing the command for said one of the interconnecting devices.

5. A management apparatus as claimed in claim 1, further comprising a fetch unit for fetching the execution procedure of said one of the interconnecting devices from said one of the interconnecting devices, and for storing the fetched execution procedure into said command storage unit.

6. A management apparatus as claimed in claim 5, wherein said one of the interconnecting devices stores the execution procedure in MIB (Management Information Base) of SNMP(Simple Network Management Protocol), and said fetch unit fetches the execution procedure from MIB of said one of the interconnecting devices using SNMP.

7. A management apparatus as claimed in claim 1, wherein, in case where the execution procedure includes a procedure of fetching an address of an interconnecting management apparatus for managing said one of the interconnecting devices, said execution unit fetches the address of the interconnecting management apparatus from said one of the interconnecting devices, and said execution unit manages said one of the interconnecting devices through the interconnecting management apparatus, according to the execution procedure of the command, by communicating with the interconnecting management apparatus using the address.

8. An interconnecting device for interconnecting communication in a network, the interconnecting device connecting to a management apparatus to manage the interconnecting device and generating a fetch request, the interconnecting device comprising:
a storage unit for storing an execution procedure which corresponds to a command executed by the management apparatus and processes the command;
a receiver connecting to said storage unit for receiving from the management apparatus the fetch request for fetching the execution procedure;
a transmitter connecting to said storing unit and to the management apparatus for fetching the execution procedure from the storage unit which procedure is specified by the fetch request, and for transmitting the fetched execution procedure to the management apparatus; and
a setting unit connecting to said receiver and to said transmitter for setting the interconnecting device according to a process request sent to the interconnecting device by the management apparatus, based on the execution procedure, when the management apparatus executes the command based on the execution procedure.

9. An interconnecting device as claimed in claim 8, wherein said storage unit stores the execution procedure in MIB of SNMP,
said receiver receives the fetch request as a message format based on SNMP, and
said transmitter transmits the execution procedure in the message format based on SNMP.

10. An interconnecting device as claimed in claim 8, wherein the execution procedure includes steps of:
making the management apparatus fetch an address of an interconnecting management apparatus which manages said interconnecting device; and
making the management apparatus manage said interconnecting device via the interconnecting management apparatus of the interconnecting device, by communicating with the interconnecting management apparatus.

11. A communication system comprising:
a plurality of interconnecting devices for interconnecting communication; and
a management apparatus connecting to and managing said plurality of interconnecting devices, wherein
said management apparatus includes
a command storage unit for storing one or more execution procedures, which corresponds to a common command for managing said interconnecting devices and process the command for said respective interconnecting devices,
a fetch unit for fetching the execution procedure of one of said interconnecting devices from said one of said interconnecting devices, and for storing the fetched execution procedure into said command storage unit, and
an execution unit for executing the command for said one of said interconnecting devices, by fetching the execution procedure corresponding to the command for said one of said interconnecting devices from said command storage unit, and by communicating with said one of said interconnecting devices in accordance with the execution procedure; and
said one of the interconnecting devices includes
a storage unit for storing the execution procedure, which corresponds to the command executed by said management apparatus managing said one of said interconnecting devices, and processes the command,
a receiver for receiving a fetch request to fetch the execution procedure from said management apparatus,
a transmitter for fetching the execution procedure specified by the fetch request from said storage unit, and for transmitting the fetched execution procedure to said management apparatus; and
a setting unit for setting said one of said interconnecting devices according to a process request sent to said one of said interconnecting devices by said management apparatus based on the execution procedure when said execution unit of said management apparatus executes the command based on the execution procedure.

12. A computer readable medium recording a program for a management apparatus to manage a plurality of interconnecting devices, which interconnect communication, wherein said program makes said management apparatus be operated as:
a command storage unit for storing one or more execution procedures, which correspond to a common command for managing the interconnecting devices and process the command for the respective interconnecting devices; and
an execution unit for executing the command for one of the interconnecting devices, by fetching the execution procedure corresponding to the command for said one of the interconnecting devices from said command storage unit, and by communicating with said one of the interconnecting devices in accordance with the execution procedure.

13. A management method of managing a plurality of interconnecting devices for interconnecting communication, comprising steps of:
storing one or more execution procedures, which corresponds to a common command for managing the interconnecting devices and process the command for the respective interconnecting devices; and
executing the command to one of the interconnecting devices, by fetching the execution procedure corresponding to the command for said one of the interconnecting devices from said command storage unit, and by communicating with said one of the interconnecting devices in accordance with the execution procedure.

14. A management apparatus for managing a plurality of interconnecting devices which interconnects communication, comprising:
a communication unit connecting to the interconnecting devices;
an issue unit connecting to said communication unit and issuing a common command which is common to the plurality of the interconnecting devices;
a command storage unit which stores one or more execution procedures, which correspond to the common command and process the command for the respective interconnecting devices; and
an execution unit connecting to said issue unit, said communication unit and said command storage unit, said execution unit executing the command for one of the plurality of interconnecting devices by fetching the execution procedure corresponding to the command for said one of the interconnecting devices stored in said command storage unit, and said execution unit communicating with said one of the interconnecting devices through said communication unit in accordance with the execution procedure.
